(19) United States
(12) Patent Application Publication
(10) Pub. No.: US 2006/0268843 A1
(43) Pub. Date: Nov. 30, 2006

(54) Server arrangement, service distribution module and method for providing telecommunications services

(75) Inventors: Uwe Spitzer, Backnang (DE); Andreas Breiholz, Grossbottwar (DE); Josef Kneer, Weil der Stadt (DE); Dieter Gramsch, Korntal (DE); Roland Leibfarth, Dettingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/439,259

(22) Filed: May 24, 2006

(30) Foreign Application Priority Data
May 25, 2005 (EP) 05291226.8

(51) Int. Cl. H04L 12/66

(52) U.S. Cl. 370/352; 370/401

(57) ABSTRACT

The invention relates to a server arrangement, a service distribution module for a server arrangement and a method for providing telecommunications services using a server arrangement, in particular a Service Control Point (SCP1), comprising the steps: receiving a service request message (M1-M3) by a communication interface (CI) of the server arrangement, distributing the service request of the service request message (M1-M3) to a first or to at least one second service provision means (S12) depending on the service request message (M1-M3), and providing a first service by the first service provision means (S11) or providing at least one second service by the at least one second service provision means (S12). The service distribution means (SDM) concatenates the first (S11) and the at least one second service provision means (S12) depending on at least one concatenation condition (CC1).

The invention is based on a priority application, EP 05291226.8, which is hereby incorporated by reference.

### TECHNICAL FIELD

The invention relates to the field of telecommunications and more particularly to a server arrangement, a service distribution module for a server arrangement and a method for providing telecommunications services using a server arrangement.

### BACKGROUND OF THE INVENTION

The server arrangement is for example a Service Control Point (SCP) of a telecommunications network, for example an Integrated Services Digital Network (ISDN) or a mobile network. A user dials a service number for a call at his terminal. Upon that call request, the network, in particular a Service Switching Function of the network, transmits a service request message to the Service Control Point. The Service Control Point provides the service that is requested by the service request message. The first service is for example a free phone service (0800-service) which is requested by service messages of a first type. If the terminal and/or the Service Switching Function requests a second service, for example a local number portability service, a calling card service or the like, it sends a second service request message. Both service request messages must be routed through the full protocol stack of the communications network. Furthermore, the service request message as such does quite often not contain all information that is necessary to provide the requested service. In such cases the Service Control Point or server arrangement sends further inquiry messages to the Service Switching Function in order to request the information needed to complete the service. These further messages cause much traffic in the telecommunications network.

### SUMMARY OF THE INVENTION

It is therefore an object of the invention to provide for optimized service provision in a telecommunications network.

This object is attained by a server arrangement for providing telecommunications services, the server arrangement comprising:
a communication interface for receiving service request messages,
a first service provision means providing a first service,
at least one second service provision means providing at least one second service,
a service distribution means for distributing the service request of the service request message to the first or the at least one second service provision means depending on the service requested by the respective service request message, wherein
the service distribution means is operable to concatenate the first and the at least one second service provision means depending on at least one concatenation condition.

This object is further attained by a service distribution module for a server arrangement for providing telecommunications services, the server arrangement having a communication interface for receiving service request messages, the server arrangement having further a first service provision means providing a first service and at least one second service provision means providing at least one second service, wherein
the service distribution module comprises program code executable by a processor of the server arrangement
the service distribution module comprises distribution means for distributing the service request of the respective service request message to the first or the at least one second service provision means depending on the service requested by the respective service request message, and
the service distribution means is operable to it concatenate the first and the at least one second service provision means depending on at least one concatenation condition.

This object is also attained by a method for providing. telecommunications services using a server arrangement comprising the steps of:
receiving a service request message by a communication interface of the server arrangement,
distributing the service request of the service request message to a first or to at least one second service provision means depending on the service request message,
providing a first service by the first service provision means or providing at least one second service by the at least one second service provision means,
wherein
the service distribution means concatenates the first and the at least one second service provision means depending on at least one concatenation condition.

The idea underlying the invention is that the originating party, for example a Service Switching Function, that is requesting a service, needs not to send individual service request message for each service that is needed rather than only one service request message for a set of services which are linked at the server arrangement side, i.e. at a Service Control Point according to the invention. Therefore, only the traffic in connection with the first service request message has to be transmitted to the telecommunications network or the traffic which it costs by further inquiries of the Service Control Point in connection with this first service request message. The information thereby collected is preferably stored at the server arrangement. Thus, the server arrangement can use this information to provide both the first service and the at least one second service. It is not necessary that the server arrangement starts a second dialog with the service requesting party in order to collect the same information as already collected in connection with the first service. Therefore, the service provision rate or speed is increased and the traffic through the telecommunications network is reduced. The first service and the at least one second service are preferably provided as a result of one originating service request message.

A main idea is to have some independent services which can be combined in a flexible way in dependence of one or more concatenation conditions, e.g. an incoming call and/or results of previous service or services and/or runtime configuration data. Preferably, the at least one concatenation condition is configurable at the server arrangement which means that further concatenation conditions may be added, conditions may be deleted or amended. Therefore, the concatenation of services according to the invention is dynamic.

The server arrangement provides the first service and the combined at least one second service so to say as one integrated service.

The service distribution means forwards service request messages to one or more services depending on its configuration data that may comprise for example: number of services and/or a list of services, e.g. names of shared libraries and/or number of instances per service and/or service logic tables containing concatenation conditions.

The service distribution means concatenates the first and the at least one second service in such a way that the first and the at least one second service are provided as a result of one originating service request message.

Further advantages of the invention are defined in the subclaims.

### BRIEF DESCRIPTION OF THE DRAWINGS

The invention will become more apparent by reference to the following description of several embodiments taken in conjunction with the accompanying drawings in which:

FIG. 1 is a functional diagram of a telecommunications network with a Service Control Point in accordance with the invention;

FIG. 2 is a functional block diagram of the Service Control Point of FIG. 1, the Service Control Point being in dialog with a service requesting party, and

FIG. 3 a functional block diagram of a Service Control Point in accordance with the invention.

### DETAILED DESCRIPTION OF THE INVENTION

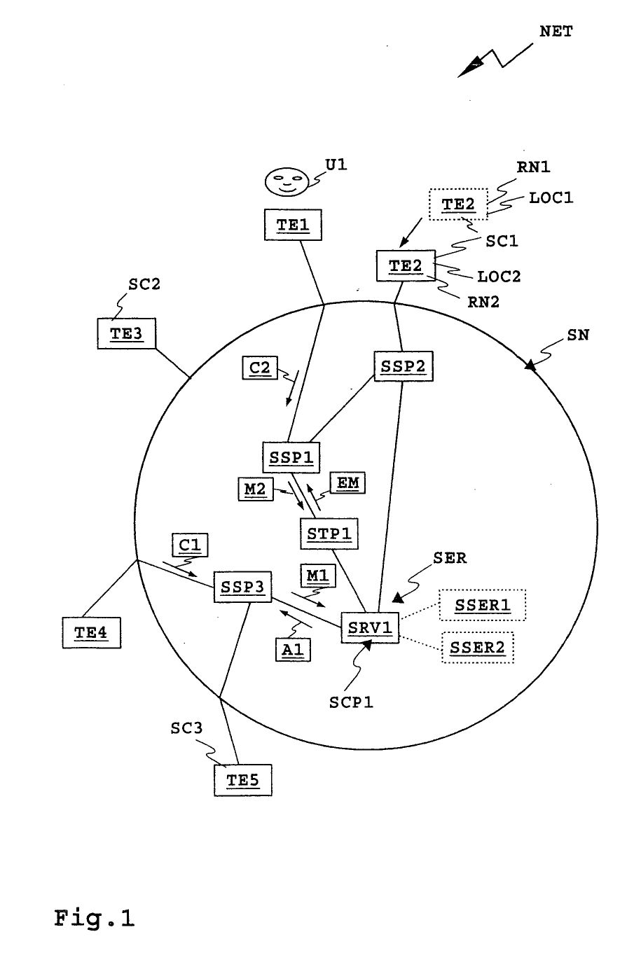

FIG. 1 shows a telecommunications network NET, that may comprise a fixed network or subnetwork, e.g. an Integrated Services Digital Network (ISDN) and/or a mobile network or subnetwork, for example a GSM network (=Global System for Mobile Communications). Besides voice communication, of course, video and data communication may be possible over the network NET.

The communications network may be at least partly a circuit-switched network and/or a packet oriented network. The network NET comprises a number of interconnected exchanges, for example exchanges SSP1, SSP2 and SSP3. The exchanges SSP1, SSP2 and SSP3 may be Service Switching Points and provide Service Switching Functions for terminals TE1-TE5 that are shown by way of example. The terminals TE1-TE5 may be mobile terminals, for example mobile phones, fixed terminals, computers or the like. The exchanges SSP1-SSP3 are interconnected by a signaling network SN which may be based for example on the ITU-T signaling system No. 7. In the present case, the Signaling Network SN is based on base protocol BP, for example MTP or TCP/IP (MTP=Message Transfer Part; TCP/IP Transmission Control Protocol/Internet Protocol).

The network NET provides, inter alia, services in accordance with the definitions of an Intelligent Network, for example free phone services, universal number services, calling card services, local number portability services, wireless roaming, personal communications services (PCS) or the like.

In the event of emergency the universal number service is helpful. For example the terminal TE4 sends a call C1 to the exchange SSP3 requesting help in a car breakdown. The exchange SSP3 detects that the call C1 is related to a telecommunications service and forwards a request message M1 to a Service Control Point SCP1 containing a server arrangement SER in accordance with the invention. The Service Control Point SCP1 detects for example based on the originating address or telephone number of the terminal TE4 which of the service centers SC2 or SC3 with terminals TE3, TE5, respectively, is closer to the location of the terminal TE4. In the present case terminal TE5 is the closest one and consequently the Service Control Point SCP1 provides in a response message Al the address i.e. the telephone number, of the terminal TE5. Based on this destination number or destination address, the exchange SSP3 completes the call from terminal TE4 to terminal TE5.

However, if a second service, for example number portability service or the like, is requested, the exchange or Service Switching Point SSP3 would be obliged to send a second service request message to the Service Control Point SCP1. This causes a lot of traffic within the communications network NET, extends the call set up time, needs a lot of resources like telecommunications links or connections. In this scenario the invention is very helpful:

Also user U1 needs assistance from a service center which is close to his present location. Therefore, he calls a universal number that is valid independent on the current location of user U1. Terminal TE1 send a call or call request C2 to the exchange SSP1. The exchange SSP1 generates accordingly a service request message M2 that is forwarded on the signaling network SN via a Service Transfer Point STP1 by way of example. The Service Transfer Point STP1 forwards the service request message M2 further to the Service Control Point SCP1. Of course, the request message M2 could also be forwarded in another embodiment of the invention directly from the Service Switching Point SSP1 via a direct link or connection DLI to the Service Control Point SCP1.

The Service Switching Point SSP2 contains a Service Switching Function SSF1 that represents a TCAP user TCU (TCAP=Transaction Capabilities Application Part). The service request message M2 is forwarded through the full protocol stack PS which contains in the present embodiment TCAP, SCCP and a base protocol BP which could be for example MTP or TCP/IP (SCCP=Signaling Connection Control Part). SCCP is used as a transport layer for the TCAP service request message M2. The base protocol BP is used as a transport layer for the SCCP messages.

Similar as the terminal TE1, the originating party of the service request message M2 also the receiving party, the server arrangement SER/the Service Control Point SCP1 represents a TCAP user.

The server arrangement SER may comprise one single server SVR1 or a computer cluster containing one or more processors PR for the execution of program code of program modules that are stored in a memory MEM containing volatile or non volatile memory, hard discs or the like.

In the present case the server arrangement SER has a layered structure with a communication layer CLY, a service distribution layer SDLY and a service layer SERLY. The communication layer CLY contains a communication interface CI with a protocol manager PMAN which comprises several program modules executable by the processor PR. The protocol manager PMAN handles for example the extraction of the service request message M2 from the protocols BP, SCCP and TCAP of the protocol stack PS.

Then, the protocol manager PMAN forwards the message M2 to the service distribution layer SDLY containing service distribution means SDM. The service distribution means SDM contain a service distributor SDI1 that receives the service request message M2 and distributes it to a service logic controller SLC1 that is also a part of the service distribution means SDM. Basically, the service distributor SDI1 could address a further service logic controller (not shown in the figure) if that service logic controller were better suited to treat the service request message M2. If a service request message requests for example a calling card service, the service distributor SDI1 would forward this service request to the second service logic controller (not shown in the figure). However, the service request message M2 concerns a universal number service and is therefore forwarded to the service logic controller SLC1.

In the present case, the service logic controller SLC1 and the service distributor SDI1 are separate program modules with program code executable by the processor PR. Instead of a structured architecture with two separate program modules, the service logic controller SLC1 and the service distributor SID1, one could provide one single program module performing the same functionality.

The service logic controller SLC1 can address services or service instances S11, S12, S13-S1N of a service group SG1. The service instances S11-S1N and preferably also the database DB1 are service provision means SPM of the service layer SERLY.

The service instances S11 and S13 provide for example a universal number service of a first and a second type, respectively. The service instance S13 comprises basically the same program code as the service instance S11. However, the service instances S11 and S13 are differently configured by configuration data or service data D11 and D13, respectively, stored in a database DB1 being contained in the Service Control Point SCP1.

The database DB1 may in an alternative embodiment of the invention also at least partly be a database remote from the Service Control Point SCP1, for example a number portability database contained in a remote server (not shown).

The service instance S12 provides a number portability service using number portability data or service data D12. Further services or service instances S1N may concern calling card services, wireless roaming services, personal communications services (PCS) or the like using service data D1N also stored in the database DB1.

As the service request message M2 is for example the BEGIN message BEG of a TCAP dialog DIA1 or an IAM message of an ISUP dialog (ISUP=ISDN User Part), the service logic controller SLC1 checks upon receipt of the service request message M2 whether there is already a call context available for the requested service. Search conditions for the detection of an already existing call context is data contained in the respective received service request message, for example an originating address ON and/or a destination address DN and/or a logical network identifier of a network NET and/or a unique message identifier, e.g. a transaction identifier TID, or the like. If there is no call context for the service request message M2, the service logic controller SLC1 generates a new call or message context CON1 in a call or message context memory CCM. The context CON1 contains data necessary to provide the service requested by the message M2, e.g. the transaction id TID, the originating address or number ON of the terminal TE1 and further data as described below.

The service distributor SDI1 and/or the service logic controller SLCL detect that the service request of the service request message M2 does not contain the complete information needed to provide the requested service.

The service request message M2 contains e.g. only a request for the universal number service, i.e. the request for a service, which could be provided by one of the service centers SC1-SC3, and the originating address or number ON of the terminal TE1. However, this information is not sufficient to perform the requested service.

Therefore, the service distributor SDI or the service logic controller SLC1 sends an inquiry message EM, e.g. a TCAP query message, to the originating party or TCAP user TCU. With a message EM the Service Control Point SCP1 requests for example the destination number or address DN of the requested service. The TCAP user TCU responds with a message M3, e.g. a so-called CONTINUE message CON, e.g. a TCAP response message, in which the requested destination address or number DN is contained.

The service logic controller SLC1 determines by means of transaction id TID that was already contained in message M2 that the new message M3 belongs to the dialog DIA1. The service logic controller SLC1 stores in the call context CON1 preferably only the essential information of the dialog DIA1, e.g. at least the originating address ON, the destination address DN and the transaction identifier TID. However, also the complete dialog DIA1 may be stored in the call context CON1. Furthermore, the call context CON1 contains preferably a reference REF1 to a service logic table SLT1, a reference to a current entry EN1 in the table SLT1. The call context CON1 may comprise further data, for example an originating server address if the call context CON1 has been received from a server remote from the Service Control Point SCCP1 and/or a forward indicator or address of another service server according to the invention, if the call context CON1 has been forwarded to this other server. The call context CON1 can also comprise further data, for example a last incoming message in connection with a service provision, e.g. message M2, or an indicator to that message and/or a message that has to be sent next in connection with the service provision.

In the above first scenario the service logic controller SLC1 collects all necessary information prior to addressing the service instance S11. However, in a preferred embodiment of the invention the service logic controller SLC1 and the service instance S11 are already in dialog while collecting the necessary information:

The service logic controller SLC1 determines by means of a service logic table SLT1 that the service request message M2 concerns a universal number service. The service logic table SLT1 is linked with the context memory CON1. The service request message M2 contains for example a service request identifier UN for universal number services. According to an entry EN1 a service identifier SID1 is assigned to the service request identifier UN. The service identifier SID1 indicates that the service instance S11 is able to perform the universal number service. Thus, the service logic controller SLC1 addresses the service instance S11. The service instance S11 determines that still information is necessary to perform the service and returns for example the return value R11 indicating that further information, in the present case the destination number DN, is still needed to provide the full service. Thus, the service logic controller SLC1 sends the inquiry message EM requesting the destination number DN.

If also the destination number DN is available the service logic controller SLCL follows the links of the entry EN1 and addresses the service instance S11 again with this new collected data. The service instance S11 is now able to perform the complete universal number service upon receipt of the first service call of the service logic controller SLC1. The service instance S11 sends the return value R1x comprising all information necessary for the completion of the universal number service. The Service Control Point SCP1 could now basically instruct the Service Switching Points SSP1, SSP2 to complete the call request C2 and to connect terminal TE1 to terminal TE2. The terminal TE2 belongs to a service center SC1 which is closer than the service center SC2 to the user U1.

However, the service center SC1 has moved from a former location LOC1 with a destination address RN1 to a new location LOC2 with a new destination address or destination number RN2. In a conventional Intelligent Network architecture the Service Switching Points SSP1 and/or SSP2 would have to perform a number portability service as a second service which means that the full dialog DIA1 over the protocol stack PS would have to be repeated. According to the invention this is not necessary:

The entry EN1 of the service logic table SLT1 contains an assignment of the return value R1x to a service identifier SID2 that belongs to the service instance S12 which performs a number portability service. Accordingly, the service logic controller SLCL addresses the service instance S12 which determines by means of the service data D12, for example a number portability database, the destination number RN2 of the terminal TE2.

The service instance SN2 returns the destination number RN2 in connection with a return value R12. The return value R12 is assigned to an end indicator END. Consequently, no further service is concatenated according to the service logic table SLT1. The full service package consisting of universal number service and concatenated number portability service is completed and the Service Control Point SCP1 completes in cooperation with the Service Switching Points SSP1, SSP2 the call request C2 from terminal TE1 to terminal TE2 with its new destination number RN2.

The link from the return value R11 to service identifier SID2 is a concatenation condition according to the invention. It has to be noted, that further services may be concatenated, for example the services S13-S1N or the like. Furthermore other concatenation conditions are possible, for example a runtime configuration data, an incoming call or information of an incoming call or the like. Also, the service instances S11, S12, S13-S1N may be addressed as individual, non-concatenated services.

The Service Control Point SCP1 is thus able to perform also conventional services that are not concatenated. For example the entry EN2 of the service logic table SLT1 concerns such kind of services. If for example a service request identifier B2 is addressed by a request message M4, this identifier B2 is assigned to a service identifier SID3 of the service instance S13. The return value R13 of the service instance R13 is linked with an END-indicator which means that the service is already completed. Upon receipt of the service request message M4 the service logic controller SLC1 generates a new call context CON2.

The entries EN1, EN2 could be parts of two different service logic tables.

The service logic table SLT1 is preferably configurable, for example by a user interface, preferably by a graphical user interface.

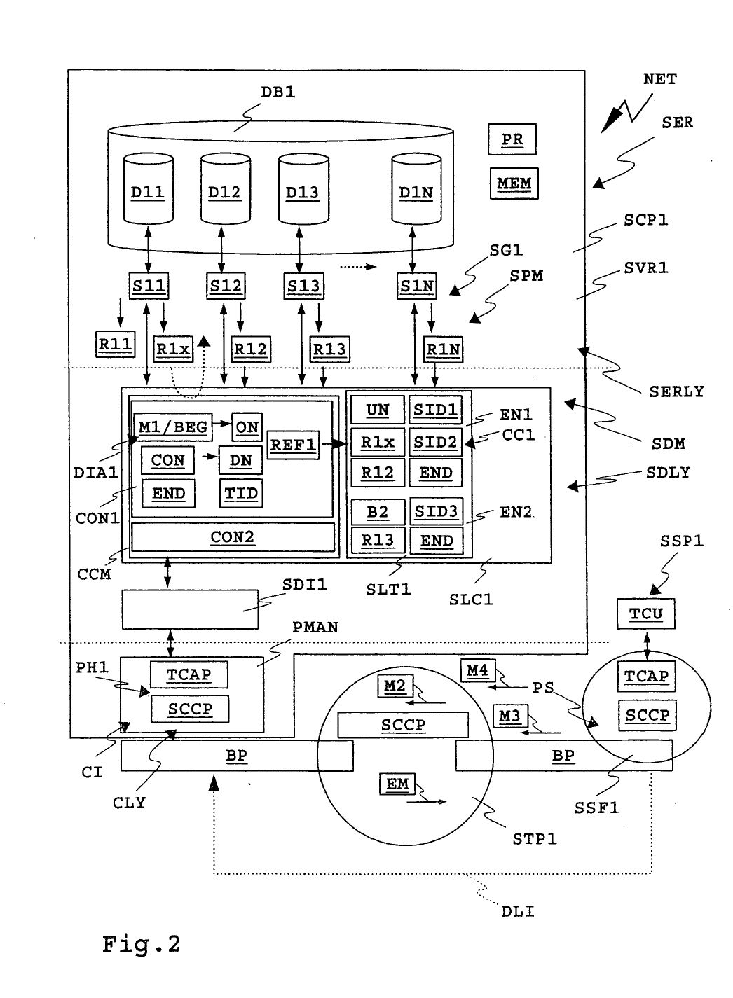

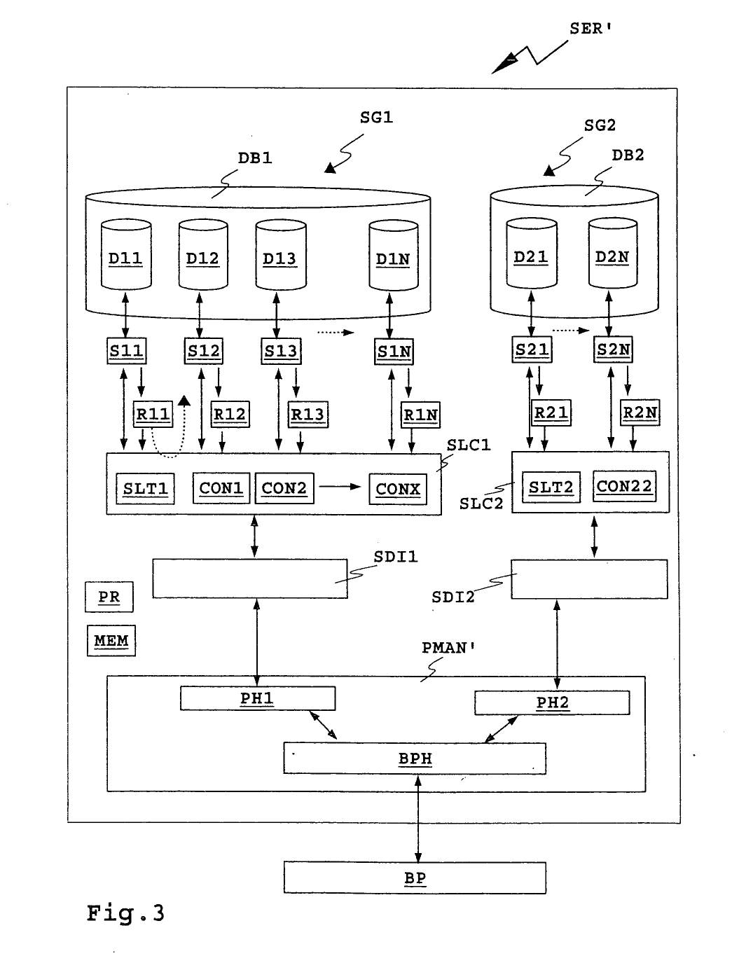

A server arrangement SER′ shown in FIG. 3 is slightly different from the server arrangement SER according to FIGS. 1, 2. As far as both server arrangements SER, SER′ comprise the same components or functionality the same denominators are used.

The server arrangement SER1 performs beside the TCAP services as described above services related to at least one further protocol. For example, service instances S21-S2N of a second service group SG2 belong to SCCP relay services and/or ISUP services. A protocol handler PH1 of a protocol manager PMAN′ is related to the TCAP-SCCP services as described above. A second protocol handler PH2 is for example handling SCCP messages. Furthermore, the protocol handler PH2 could comprise an MTP3 transcoder and/or an ISUP transcoder related to ISUP services. Of course, the protocol manager PMAN may comprise further protocol engines for other protocols. A base protocol handler BPH is handling a base protocol or transport protocol for the transport of the SCCP or ISUP messages as described above. In connection with the server arrangement SER′ the base protocol BP is for example a TCP/IP.

The ISUP services or SCCP relay services are handled by a service distributor as DI2 and a service logic controller SLC2 working similar as the service distributor SDI1 and the service logic controller SLCL. The service logic controller SLC2 comprises a service logic table SLT2 and a context memory CON22. The service instances S21-S2N use a database DB2 containing service data SD1 containing service data D21-D2N assigned to the service instances S21-S2N. The service instances S2N-S2N generate return values or codes R21-R2N, which could be evaluated by the service logic controller SLC2 in order to concatenate or link the service instances S21-S2N as described above.

With reference to FIG. 1 a distributed service provision architecture according to the invention is shown. The services of the service instances S11, S12 could be performed by service subservers SSER1, SSER2 that are separate from the Server SRV1 of the Service Control Point SCP1. The Server SRV1 could for example instead of addressing the service instances S11 and S12 use the subservers SSER1, SSER2 performing the same services. The Server SRV1 forwards preferably the call context CON1 first to the service subserver SSER1 in order to complete the universal number service and subsequently, according to the service logic table SLT1 and the service identifier SID2, to the service subserver SSER2. The Server arrangement SER is designed such that it forwards the respective request message context to a first service server SSER1 providing the first service or to at least one second service server providing at least one second service.

If the full service package of the service instances S11, S12 is completed, locally by the Server SRV1 and/or remotely by the subservers SSER1, SSER2, the call context CON1 is released.

The service logic controller SLC may comprise further data, for example the number of services S11-S1N that may be performed, a list of services, that may be provided, for example names of shared libraries, the number of instances per service, a number of a service logic table and further service logic tables defining the concatenation of service instances as described above.

The service distribution means or module SDM may be stored on a storage means for example a hard disc, an optical disc like a DVD or the like.

1. Server arrangement, in particular a Service Control Point, for providing telecommunications services, the server arrangement comprising:
a communication interface for receiving service request messages,
a first service provision means providing a first service,
at least one second service provision means providing at least one second service, and
a service distribution means for distributing the service request of the service request message to the first or the at least one second service provision means depending on the service requested by the respective service request message,
wherein
the service distribution means is designed in such a way that it concatenates the first and the at least one second service provision means depending on at least one concatenation condition, the at least one concatenation condition comprising configurable configuration data for linking services whereby concatenation conditions can be added or deleted or amended.

2. Server arrangement in accordance with claim 1 wherein the service distribution means activates the at least one second service provision means subsequent to the first service provision means.

3. Server arrangement in accordance with claim 1 wherein the at least one condition comprises a result, in particular a return value, of the first service provision means and/or a call context of service request message.

4. Server arrangement in accordance with claim 1 having a layered structure wherein the service distribution means is part of a service distribution layer between a service layer comprising the first service provision means and the at least one second service provision means and a communication layer comprising the communication interface.

5. Server arrangement in accordance with claim 1 comprising a service concatenation table in which the at least one concatenation condition is stored.

6. Server arrangement in accordance with claim 1 wherein the service distribution means comprises a service request message context memory in which the service distribution means stores a context of the respective service request message, the context comprising a unique identifier of the service request message and/or an originating address of the service request message and/or a destination address contained in the service request message and/or network identifier of an originating network or subnetwork of the service request message.

7. Server arrangement in accordance with claim 1 wherein the service request message context memory is linked with the concatenation table or is a part of the concatenation table.

8. Server arrangement in accordance with claim 1 wherein it comprises a first service server providing the first service and at least one second service server providing the at least one second service.

9. Service distribution module for a server arrangement, in particular a Service Control Point, for providing telecommunications services, the server arrangement having a communication interface for receiving service request messages, the server arrangement having further a first service provision means providing a first service and at least one second service provision means (S12) providing at least one second service,
the service distribution module comprising program code executable by a processor of the server arrangement
the service distribution module comprising distribution means for distributing the service request of the respective service request message to the first or the at least one second service provision means depending on the service requested by the respective service request message, and
the service distribution means being designed in such a way that it concatenates the first and the at least one second service provision means depending on at least one concatenation condition, the at least one concatenation condition comprising configurable configuration data for linking services whereby concatenation conditions can be added or deleted or amended.

10. Method for providing telecommunications services using a server arrangement, in particular a Service Control Point, comprising the steps of:
receiving a service request message by a communication interface of the server arrangement,
distributing the service request of the service request message to a first or to at least one second service provision means (S12) depending on the service request message, and
providing a first service by the first service provision means or providing at least one second service by the at least one second service provision means,
wherein
the service distribution means concatenates the first and the at least one second service provision means depending on at least one concatenation condition the at least one concatenation condition comprising configurable configuration data for linking services whereby concatenation conditions can be added or deleted or amended.
